(19) United States
(12) Patent Application Publication
(10) Pub. No.: US 2012/0127418 A1
(43) Pub. Date: May 24, 2012

(54) CONDUCTIVE LIGHT ABSORPTION LAYER COMPOSITION, CONDUCTIVE LIGHT ABSORPTION LAYER, AND LIQUID CRYSTAL DISPLAY EMPLOYING THE SAME

(76) Inventors: Chin-Cheng WENG, Kaohsiung City (TW); Yu-Chin Lin, Hsinchu County (TW); I-Jein Cheng, Changhua County (TW); Kuo-Tung Huang, Hsinchu County (TW)

(21) Appl. No.: 13/033,020

(22) Filed: Feb. 23, 2011

(30) Foreign Application Priority Data
Nov. 19, 2010 (TW) 99139924

(51) Int. Cl. G02F 1/1333; H01B 1/04; H01B 1/02; H01B 1/00

(52) U.S. Cl. 349/158; 252/500; 252/502; 252/512

(57) ABSTRACT

A conductive light absorption layer composition, a conductive light absorption layer, and a liquid crystal display employing the same are provided. The conductive light absorption layer composition includes: 10-40 parts by weight of an adhesion agent; 40-50 parts by weight of a non-conductive nano-pigment; 10-25 parts by weight of a conductive material; 10-25 parts by weight of a surfactant; and 0.1-1.0 parts by weight of an interface modifying agent.

### CROSS REFERENCE TO RELATED APPLICATIONS

This application is based upon and claims the benefit of priority from the prior Taiwan Patent Application No. 99139924, filed on Nov. 19, 2010, the entire contents of which are incorporated herein by reference.

### BACKGROUND

1. Technical Field

The disclosure relates to a conductive light absorption layer and a liquid crystal device employing the same and, more particularly, to conductive light absorption layer with reduced sheet resistance and a liquid crystal device employing the same.

2. Description of the Related Art

Media systems exist that maintain electronically changeable data without power. Such systems can be electrophoretic (Eink), Gyricon, or polymer dispersed cholesteric materials.

An example of electronically updateable displays can be found in U.S. Pat. No. 3,600,060, which discloses a device having a coating via dried emulsion of a composition of cholesteric liquid crystals and aqueous gelatin to form a field-responsive, bistable display. U.S. Pat. No. 3,816,786 discloses a layer of encapsulated cholesteric liquid crystals responsive to an electric field. The electrodes in the patent can be transparent or non-transparent. It is disclosed that one electrode must be a light absorbing electrode, and it is suggested that the light absorbing electrode be prepared from paints containing conductive material such as carbon black.

Fabrication of flexible, electronically written display sheets is disclosed in U.S. Pat. No. 4,435,047. A substrate carries a first conductive electrode, one or more layers of encapsulated liquid crystals, and a second electrode of electrically conductive ink. The conductive inks form a background for absorbing light, so that the information-bearing display areas appear dark in contrast to background non-display areas. An electrical potential, applied to opposing conductive areas, operates on the liquid crystal material to expose display areas. Because the liquid crystal material is nematic liquid crystal, the display ceases to present an image when de-energized; that is, in the absence of a field. Dyes in either the polymer encapsulant or liquid crystal material absorb incident light. The dyes are part of a solution, and not solid submicron particles. A chiral dopant can be further employed therein for improving the response time of the nematic liquid crystal.

U.S. Pat. No. 5,251,048 discloses a light modulating cell having a polymer dispersed chiral nematic liquid crystal. The chiral nematic liquid crystal has a property of being electrically driven between a planar state, reflecting a specific visible wavelength of light, and a focal conic state, transmitting forward scattering light. Chiral nematic liquid crystals, also known as cholesteric liquid crystals, potentially, in some circumstances, have the capacity of maintaining one of a multiple of given states in the absence of an electric field. Black paint can be applied to the outer surface of a rear substrate to provide a light absorbing layer, forming a non-changing background outside of a changeable display area.

U.S. Pat. No. 6,707,517 discloses a display with a field spreading layer. The display includes an electrode, a liquid crystal layer, and a field spreading layer disposed between the electrode and the liquid crystal layer, wherein the field spreading layer is made by coating of a composition including conductive polymer, gelatin, and solvent. Due to strong intermolecular interaction between polymer and gelatin, the viscosity of the composition rapidly rises from solvent which vaporizes during the coating process. Therefore, methods for forming a film via the composition are limited. For example, a film made from the above composition can be prepared by slide coating or slot die processes. However, the film made from the above composition would exhibit inferior film reliability and high variation in thickness.

Further, U.S. Pat. No. 7,564,528 discloses a display with a conductive layer for reducing drive voltage, wherein the conductive layer includes conducting polymer and conducting carbon particles. The conductive layer, however, induces field accumulation between the two electrodes of the display, resulting in an uneven field distribution. Further, since the conductive layer exhibits high sheet resistance (between 1×10⁹ and 1×10¹¹ Ω/□ (ohm per square)), the display employing the conductive layer has a driving voltage of more than 140V.

Therefore, it is desirable to devise a novel Conductive light absorption material that solves the aforementioned problems.

### SUMMARY

The disclosure provides a conductive light absorption layer composition for forming a conductive light absorption layer employed in a liquid crystal display.

An exemplary embodiment of a conductive light absorption layer composition, as a uniform solution in a solvent, includes: 10-40 parts by weight of an adhesion agent; 40-50 parts by weight of a non-conductive nano-pigment; 10-25 parts by weight of a conductive material; 10-25 parts by weight of a surfactant; and 0.1-1.0 parts by weight of an interface modifying agent.

In another exemplary embodiment of the disclosure, a conductive light absorption layer is provided, wherein the conductive light absorption layer includes a film made by coating the aforementioned conductive light absorption layer composition.

Yet another exemplary embodiment of the disclosure provides a liquid crystal display, including: a transparent substrate; a transparent electrode, disposed on the transparent substrate; a liquid crystal layer, disposed on the transparent electrode; a conductive light absorption layer, disposed on the liquid crystal layer, wherein the conductive light absorption layer is made by coating the aforementioned conductive light absorption layer composition; and an electrode, disposed on the conductive light absorption layer.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 is a cross section of a liquid crystal display disclosed by an embodiment of the disclosure.

### DETAILED DESCRIPTION

The disclosure provides a conductive light absorption layer composition which includes an adhesion agent, a non-conductive nano-pigment, and a conductive material, and further includes an interface modifying agent. Due to the addition of the interface modifying agent, the intermolecular interaction between the conductive material (such as conductive polymer) and the adhesion agent can be reduced, such that the viscocity of the conductive light absorption layer composition can be maintained within a predetermined range during a coating process (preventing the viscocity of the conductive light absorption layer composition from rapidly rising during solvent vaporization). Therefore, the dosage of the conductive material can be increased for reducing the sheet resistance of an obtained conductive light absorption layer. A conductive light absorption layer made of the conductive light absorption layer composition of the disclosure has a sheet resistance of between 1×10⁵-1×10⁸ Ω/□, and a liquid crystal display employing the conductive light absorption layer has a reduced driving voltage of about 80V.

The conductive light absorption layer composition of the disclosure, as a uniform solution in a solvent, includes: 10-40 parts by weight of an adhesion agent; 40-50 parts by weight of a non-conductive nano-pigment; 10-25 parts by weight of a conductive material; 10-25 parts by weight of a surfactant; and 0.1-1.0 parts by weight of an interface modifying agent, wherein the solvent can be water, alcohol, ketone, ether, or cosolvent thereof.

The adhesion agent can be hydrophilic or water-soluble natural-occurring substances, such as cellulose esters, gelatin, gelatin derivatives, polysaccaharide, casein, or the like. Further, the adhesion agent can also include synthetic water permeable colloids, such as acrylamide polymers, poly(vinyl alcohol) and its derivatives, hydrolyzed polyvinyl acetates, polymers of alkyl and sulfoalkyl acrylates and methacrylates, polyamides, polyvinyl pyridine, acrylic acid polymers, maleic anhydride copolymers, polyalkylene oxide, methacrylamide copolymers, maleic acid copolymers, vinyl amine copolymers, methacrylic acid copolymers, acryloyloxyalkyl acrylate and methacrylates, vinyl imidazole copolymers, vinyl sulfide copolymers, homopolymer or copolymers containing styrene sulfonic acid, or combinations thereof. In the disclosure, the adhesion agent is gelatin.

In the disclosure, the term “non-conductive nano-pigment” means that the pigment has a grain size of less than 1 μm, and can be obtained via a milling process for dispersing. The non-conductive nano-pigment exhibits superior light absorption efficiency when employed as a thin layer or a submicron layer and is suitable for serving as a pigment of a conductive light absorption layer composition of the disclosure.

The conductive light absorption layer composition of the disclosure can employ a single non-conductive nano-pigment (single color), or a mixture of a various colored non-conductive nano-pigments (such as a combination of yellow-red-cyan or red-green-blue). For example, the conductive light absorption layer composition can include a pigment combination including three different color non-conductive nano-pigments: a yellow pigment with an average grain size of less than 120 nm, a magenta red pigment with an average grain size of less than 120 nm, and a mixture of a cyan pigment and blue pigment (with a weight of 15:4) with an average grain size of less than 110 nm. Illustrative examples of the pigment include compounds classified into a group of pigments according to a color index (C.I.; issued by The Society of Dyers and Colourists Co.), having the following color index numbers, such as Pigment Red 122, Pigment Red 202, Pigment Red 206, Pigment Red 209, Pigment Red 177, Pigment Red 254; Pigment Yellow 13, Pigment Yellow 55, Pigment Yellow 119, Pigment Yellow 138, Pigment Yellow 139, Pigment Yellow 168; Pigment Green 7; Pigment Green 36; Pigment Blue 15:3, Pigment Blue 15:4, and Pigment Blue 15:6.

Further, an inorganic pigment can be mixed with the pigment in order to reduce crystallization (achieving low crystallization degree or an amorphous phase). The inorganic pigment includes carbon black (such as LFF-MA7, LFF-MA100, HCF-#2650, MCF-88, M2650, MA7 (sold and manufactured by Mitsubishi), Special 4A, FW-18 (sold and manufactured by Degussa), S90B, Mogul L, M900, M1000 (sold and manufactured by Cabot), RAVEN1200, RAVEN2000 (sold and manufactured by Columbia)), graphite, or metal-containing compound (such as titanium nitride, silicon oxide, titanium oxide, barium oxide, or calcium carbonate)

Since the non-conductive nano-pigment employed by the conductive light absorption layer composition enhances light-shielding capabilities, the grain size of the non-conductive nano-pigment must be controlled to be between a specific range. In general, the non-conductive nano-pigment grain size can be less than fpm, or between 0.01-0.5 μm, of more between 0.05-0.15 μm. If the pigment has a grain size which is greater than 1 μm, the layer employing the pigment would exhibit low light absorption efficiency. To the contrary, if the pigment has a grain size of less than 0.01 μm, the layer employing the pigment would exhibit low thermal stability.

Further, the crystallization degree of the non-conductive nano-pigment alters the polarization of the light passing through the layer employing the same. In such a case, the light passing through the layer would be polarized by the non-conductive nano-pigment with anisotropic crystalline arrangement, and the polarized light would be not blocked by a polarizer, resulting in light leakage. Therefore, contrast ratio of the layer would be reduced due to the imperfect dark state. To solve the aforementioned problems, the non-conductive nano-pigment can be subjected to a milling treatment to reduce the crystallization degree to a low crystallization degree or an amorphous phase.

The conductive material of the disclosure can include a conductive polymer (such as thiophene derivative polymer (Baytron P)), conductive transparent particles (such as: tin indium oxide (ITO) particle), metal particle (such as: gold or silver particle), carbon particle (such as: conductive carbon black, delaminated graphite, fullerene, nanocapsule, or nanotube), or combinations thereof.

The interface modifying agent of the disclosure includes an ionic compound having a monovalent organic cation, bivalent organic cation, monovalent inorganic cation, or bivalent inorganic cation, including sodium-containing compound (such as NaCl, or NaOH), potassium-containing compound (such as KCl, or KOH), magnesium-containing compound (such as Mg(OH)₂, or Mg(Ac)₂), calcium-containing compound (CaCl₂), or organic cation-containing compound such as quaternary ammonium salt.

The dispersing agent may be an anionic dispersing agent, a cationic dispersing agent, or non-ionic dispersing agent, such as a polymer dispersing agent, and facilitate pigment dispersion. Further, the conductive light absorption layer composition can further include a stabilizer such as a water-soluble stabilizer.

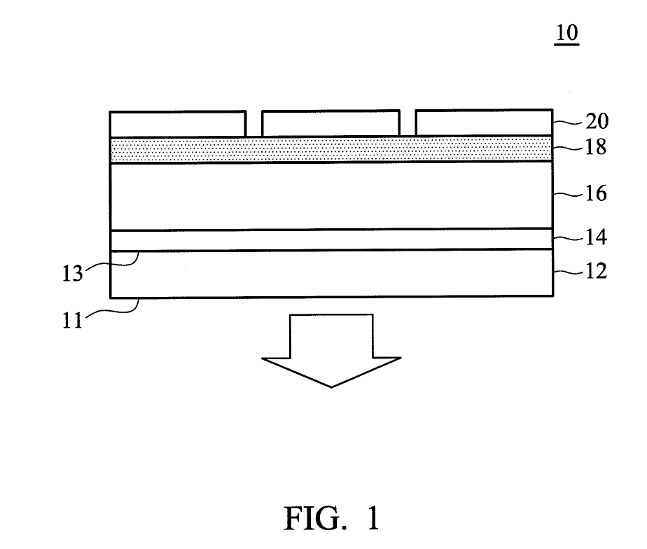

According to another embodiment, the disclosure provides a liquid crystal display. Please refer to FIG. 1, wherein the liquid crystal display 10 includes a transparent substrate 12, and the transparent substrate 12 has a bottom surface 11 (serving as the light emergent surface) and a top surface 13 opposite to the bottom surface 11. A transparent electrode 14 is disposed on the top surface 13 of the transparent substrate 12. A liquid crystal layer 16 is disposed on the transparent electrode 14. A conductive light absorption layer 18 (made by coating the above conductive light absorption layer composition) is disposed on the liquid crystal layer 16. An electrode 20 is disposed on the conductive light absorption layer 18.

The transparent substrate 12 can be a flexible transparent substrate with sufficient mechanical strength, such as polyethylene terephthalate (PET), polyethylene naphthalate (PEN), polyethersulfone (PES), polycarbonate (PC), polysulfone, phenolic resin, epoxy resin, polyester, polyimide, polyetherester, polyetheramide, cellulose acetate, aliphatic polyurethanes, polyacrylonitrile, polytetrafluoroethylenes, polyvinylidene fluorides, poly(methyl (x-methacrylates), aliphatic or cyclic polyolefin, polyarylate (PAR), polyetherimide (PEI), polyethersulphone (PES), polyimide (PI), teflon poly(perfluoro-alboxy) fluoropolymer (PFA), poly(ether ether ketone) (PEEK), poly(ether ketone) (PEK), poly(ethylene tetrafluoroethylene)fluoropolymer (PETFE), poly(methyl methacrylate), or acrylate/methacrylate copolymers (PMMA). Aliphatic polyolefins may include high density polyethylene (HDPE), low density polyethylene (LDPE), and polypropylene, including oriented polypropylene (OPP). Cyclic polyolefins may include poly(bis(cyclopentadiene)). A preferred flexible plastic substrate is a cyclic polyolefin or a polyester substrate. Various cyclic polyolefins are suitable for the flexible plastic substrate. Examples of the transparent substrate 12 include Arton® (poly(bis(cyclopentadiene)) condensate) made by Japan Synthetic Rubber Co., Tokyo, Japan; Zeanor T made by Zeon Chemicals L.P., Tokyo Japan; and Topas® made by Celanese A. G., Kronberg Germany. Afton is a that is a film of a polymer. Alternatively, the transparent substrate 12 can be a polyester substrate. Further, the transparent substrate 12 can also be a glass or quartz substrate.

The transparent electrode 14 can be a conductive metal oxide, such as indium oxide, indium tin oxide, titanium dioxide, cadmium oxide, gallium oxide, tantalum oxide, gallium indium oxide, niobium pentoxide, zinc dioxide, zinc stannate, cadmium stannate, zinc indium oxide, magnesium indium oxide, tin dioxide, cerium-containing oxide, titanium-containing oxide, zirconium-containing oxide, hafnium-containing oxide or tantalum-containing oxide. The transparent electrode 14 can be an ITO electrode formed by sputtering (such as DC sputtering or RF-DC sputtering) and have a sheet resistance of less than 3000 Ω/□. Moreover, the electrode 20 can be a metal electrode, such as aluminum, copper, nickel, cadmium, gold, zinc, magnesium, tin, indium, tantalum, titanium, zirconium, cerium, lead, palladium, or combinations thereof In general, the electrode 20 has a specific pattern for driving the display.

The liquid crystal layer 16 can be twisted nematic liquid crystal, super twisted nematic liquid crystal, ferroelectric liquid crystal, magnetic liquid crystal, or chiral nematic liquid crystal (cholesterol liquid crystal). The chiral nematic liquid crystals can be polymer dispersed liquid crystals (PDLC). The liquid crystal layer 16 of the disclosure can also employ a micro-encapsulated cholesterol liquid crystal.

The conductive light absorption layer 18 is made by the aforementioned conductive light absorption layer composition by coating. The conductive light absorption layer composition can have a solid content of between 0.5%-10% depending on the coating process, or between 2%-8%. According to an embodiment of the disclosure, the method for preparing the conductive light absorption layer composition includes the following steps: First, a pigment is dispersed by a mechanical milling treatment and a surfactant can be added optionally thereto during the treatment. Next, an aqueous solution including the adhesion agent is mixed with the pigment at a temperature, for example, of 45° C. Finally, the conductive polymer and interface modifying agent is added into the mixture, obtaining the conductive light absorption layer composition with low viscocity.

The method for forming a coating of the conductive light absorption layer composition is not limited and can include dip coating, rod coating, blade coating, air knife coating, gravure coating, reverse roll coating, extrusion coating, slide coating, slot die, or curtain coating process.

Since the conductive light absorption layer composition of the disclosure includes the interface modifying agent, the intermolecular interaction between the conductive material (such as conductive polymer) and the adhesion agent can be reduced, such that the viscocity of the conductive light absorption layer composition can be maintained within a predetermined range during a slide coating or slot die process. Therefore, the coating defeats, produced during the coating process, can be reduced. The obtained conductive light absorption layer can have a thickness of between 0.1-1.2 μm, or between 0.5-1.1 μm, an absorption wavelength of between 400-700 nm, and a sheet resistance of between 1×10⁵-1×10⁸ Ω/□.

The following examples are intended to illustrate the disclosure more fully without limiting the scope of the disclosure, since numerous modifications and variations will be apparent to those skilled in this art.

### PREPARATIVE EXAMPLE 1

A polyethylene mill jar (250 ml) was half filled with zirconia balls (having a diameter of 1 mm). Next, 5 g of a red pigment (Pigment Red 122, Sun Chemical®), 100 g of DI water, 0.5 g of DP-16 (sold by DEUCHEN®), and 1 g of SANIZOL B50 (sold by Kao Co.) were added into the mill jar. The composition was dispersed by a mill (sold by Red Devil Equipment Co) for 4 hrs. After removing the zirconia ball by filtering, a magenta red pigment dispersion was obtained. The average grain size of the particles in the magenta red pigment dispersion was determined with a light scattering apparatus (Otsuka Elect. ELS-800) and the result is listed in Table 1

### PREPARATIVE EXAMPLE 2

A polyethylene mill jar (250 ml) was half filled with zirconia balls (having a diameter of 1 mm). Next, 5 g of a yellow pigment (Pigment Yellow 4G VP 2532, Clariant®), 100 g of DI water, 0.5 g of DP-16 (sold by DEUCHEN®), and 1 g of SANIZOL B50 (sold by Kao Co.) were added into the mill jar. The composition was dispersed by a mill (sold by Red Devil Equipment Co) for 4 hrs. After removing the zirconia ball by filtering, a yellow pigment dispersion was obtained. The average grain size of the particles in the yellow pigment dispersion was determined with a light scattering apparatus (Otsuka Elect. ELS-800) and the result is listed in Table 1.

### PREPARATIVE EXAMPLE 3

A polyethylene mill jar (250 ml) was half filled with zirconia balls (having a diameter of 1 mm). Next, 5 g of blue pigment (Pigment blue 15:3, Clariant®), 100 g of DI water, 0.5 g of DP-16 (sold by DEUCHEN®), and 1 g of SANIZOL B50 (sold by Kao Co.) were added into the mill jar. The composition was dispersed by a mill (sold by Red Devil Equipment Co) for 4 hrs. After removing the zirconia ball by filtering, a cyan pigment dispersion was obtained. The average grain size of the particles in the cyan pigment dispersion was determined with a light scattering apparatus (Otsuka Elect. ELS-800) and the result is listed in Table 1.

### PREPARATIVE EXAMPLE 4

20 g of graphite was mixed with 100m1 of sulphuric acid/nitric acid (80 ml/20 ml) at room temperature. After stirring for 16 hrs, the result was washed with DI water. After drying at 100° C., the dried powder was heated at 1050° C. for 15 s to delaminate the graphite layer. After bathing in aqueous ethanol solution (70%) and being subjected to ultrasonic vibration for 8 hrs, a solution containing delaminated graphite was obtained.

### PREPARATIVE EXAMPLE 5

20 g of carbon black (MA 100) was mixed with 100 ml concentrated sulfuric acid and 8 ml of hydrogen peroxide. After stirring at room temperature for 1 hr, the result was washed by DI water. After drying at 100° C., a modified carbon black was obtained. A polyethylene mill jar (250 ml) was half filled with zirconia balls (having a diameter of 1 mm). Next, 5 g of the modified carbon black, 100 g of DI water, 0.5 g of DP-16 (sold by DEUCHEN®), and 1 g of SANIZOL B50 (sold by Kao Co.) were added into the mill jar. The composition was dispersed by a mill (sold by Red Devil Equipment Co) for 4 hrs. After removing the zirconia ball by filtering, a carbon black dispersion was obtained. The average grain size of the particles in the carbon black dispersion was determined with a light scattering apparatus (Otsuka Elect. ELS-800) and the result is listed in Table 1.

### PREPARATIVE EXAMPLE 6

A polyethylene mill jar (250 ml) was half filled with zirconia balls (having a diameter of 1 mm). Next, 5 g of ITO powder (ET-500W, ISK®), 100 g of DI water, 0.5 g of DP-16 (sold by DEUCHEN®), and 1 g of SANIZOL B50 (sold by Kao Co.) were added into the mill jar. The composition was dispersed by a mill (sold by Red Devil Equipment Co) for 4 hrs. After removing the zirconia ball by filtering, a moidified ITO powder was obtained. The average grain size of the particles in the moidified ITO powder was determined with a light scattering apparatus (Otsuka Elect. ELS-800) and the result is listed in Table 1.

TABLE 1

| | Pigment or conductive | |
|---|---|---|
| | material | grain size (nm) |
| Preparative Example 1 | Pigment Red 122 | 98.8 |
| Preparative Example 2 | Pigment Yellow 4G VP 2532 | 115.7 |
| Preparative Example 3 | Pigment Blue 15:3 15:3 | 105.5 |
| Preparative Example 5 | Carbon black | 103.8 |
| Preparative Example 6 | ITO | 68.6 |

### COMPARATIVE EXAMPLE 1

5.1 g of an adhesion agent (QR-gel, Kodak QR gelatin) and 310 g of DI water were added into a reaction bottle. After stirring at 40° C. to completely dissolve the gelatin, 80 g of the magenta red pigment dispersion of Preparative Example 1 and 40 g of the cyan pigment dispersion of Preparative Example 3 were added into the reaction bottle. After stirring for 30 min, a conductive light absorption layer composition (1) was obtained, wherein Table 2 shows component amount of the conductive light absorption layer composition (1). Next, the conductive light absorption layer composition (1) was coated on a glass substrate (connected to a circulating cooling water system) by blade coating to form a conductive light absorption layer (1) with a thickness of 1.06 μm (solid film), wherein the spacing between the blades was 20 μm.

Next, the sheet resistance of the conductive light absorption layer (1) was measured by an electrometer (Keithely 2000), and the result is shown in Table 3.

Next, a transparent substrate 12 (made of PET with a thickness of 125 μm), an electrode 14 (made of ITO with a thickness of 10-120 μm), a liquid crystal layer 16 (made of an encapsuled cholesteric liquid crystal by slot die coating with a thickness of 8-12 μm), the conductive light absorption layer (1), and an electrode 20 (made of silver with a thickness of 10-30 μm) were assembled to obtain the liquid crystal display according to FIG. 1. The driving voltage of the obtained display was measured and the result is shown in Table 3.

### COMPARATIVE EXAMPLE 2

2 g of an adhesion agent (QR-gel, Kodak QR gelatin) and 310 g of DI water were added into a reaction bottle. After stirring at 40° C. to completely dissolve the gelatin, 80 g of the magenta red pigment dispersion of Preparative Example 1, 40 g of the cyan pigment dispersion of Preparative Example 3, and 10 g of the delaminated graphite of Preparative Example 4 were added into the reaction bottle. After stirring for 30 min, a conductive light absorption layer composition (2) was obtained, wherein Table 2 shows the component amount of the conductive light absorption layer composition (2). Next, the conductive light absorption layer composition (2) was coated on a glass substrate (connected to a circulating cooling water system) by blade coating to form a conductive light absorption layer (2) with a thickness of 0.98 μm (solid film), wherein the spacing between the blades was 20 μm.

Next, the sheet resistance of the conductive light absorption layer (2) was measured by an electrometer (Keithely 2000), and the result is shown in Table 3.

Next, a transparent substrate 12 (made of PET with a thickness of 125 μm), an electrode 14 (made of ITO with a thickness of 10-120 μm), a liquid crystal layer 16 (made of an encapsuled cholesteric liquid crystal by slot die coating with a thickness of 8-12 μm), the conductive light absorption layer (2), and an electrode 20 (made of silver with a thickness of 10-30 μm) were assembled to obtain the liquid crystal display according to FIG. 1. The driving voltage of the obtained display was measured and the result is shown in Table 3.

### COMPARATIVE EXAMPLE 3

2 g of an adhesion agent (QR-gel, Kodak QR gelatin) and 310 g of DI water were added into a reaction bottle. After stirring at 40° C. to completely dissolve the gelatin, 80 g of the magenta red pigment dispersion of Preparative Example 1, 40 g of the cyan pigment dispersion of Preparative Example 3, and 100 g of the carbon black of Preparative Example 5 were added into the reaction bottle. After stirring for 30 min, a conductive light absorption layer composition (3) was obtained, wherein Table 2 shows component amount of the conductive light absorption layer composition (3). Next, the conductive light absorption layer composition (3) was coated on a glass substrate (connected to a circulating cooling water system) by blade coating to form a conductive light absorption layer (3) with a thickness of 1.02 μm (solid film), wherein the spacing between the blades was 20 μm.

Next, the sheet resistance of the conductive light absorption layer (3) was measured by an electrometer (Keithely 2000), and the result is shown in Table 3.

Next, a transparent substrate 12 (made of PET with a thickness of 125 μm), an electrode 14 (made of ITO with a thickness of 10-120 μm), a liquid crystal layer 16 (made of an encapsuled cholesteric liquid crystal by slot die coating with a thickness of 8-12 μm), the conductive light absorption layer (3), and an electrode 20 (made of silver with a thickness of 10-30 μm) were assembled to obtain the liquid crystal display according to FIG. 1. The driving voltage of the obtained display was measured and the result is shown in Table 3.

### COMPARATIVE EXAMPLE 4

5.1 g of an adhesion agent (QR-gel, Kodak QR gelatin) and 310 g of DI water were added into a reaction bottle. After stirring at 40° C. to completely dissolve the gelatin, 80 g of the magenta red pigment dispersion of Preparative Example 1, 40 g of the cyan pigment dispersion of Preparative Example 3, and 10 g of the moidified ITO powder of Preparative Example 6 were added into the reaction bottle. After stirring for 30 min, a conductive light absorption layer composition (4) was obtained, wherein Table 2 shows component amount of the conductive light absorption layer composition (4). Next, the conductive light absorption layer composition (4) was coated on a glass substrate (connected to a circulating cooling water system) by blade coating to form a conductive light absorption layer (4) with a thickness of 1.05 μm (solid film), wherein the spacing between the blades was 20 μm.

Next, the sheet resistance of the conductive light absorption layer (4) was measured by an electrometer (Keithely 2000), and the result is shown in Table 3.

Next, a transparent substrate 12 (made of PET with a thickness of 125 μm), an electrode 14 (made of ITO with a thickness of 10-120 μm), a liquid crystal layer 16 (made of an encapsuled cholesteric liquid crystal by slot die coating with a thickness of 8-12 μm), the conductive light absorption layer (4), and an electrode 20 (made of silver with a thickness of 10-30 μm) were assembled to obtain the liquid crystal display according to FIG. 1. The driving voltage of the obtained display was measured and the result is shown in Table 3.

### EXAMPLE 1

2 g of an adhesion agent (QR-gel, Kodak QR gelatin) and 310 g of DI water were added into a reaction bottle. After stirring at 40° C. to completely dissolve the gelatin, 80 g of the magenta red pigment dispersion of Preparative Example 1, 40 g of the cyan pigment dispersion of Preparative Example 3, 100 g of the carbon black of Preparative Example 5, and 100 g of Baytron Pconductive polymer were added into the reaction bottle. After stirring for 30 min, the pH value of the mixture was adjusted to 5.2 by sulfuric acid and sodium hydroxide, and then 3.0 g of a KCl aqueous solution (0.1N) serving as the interface modifying agent was added into the reaction bottle. After stirring for 1 hr, a conductive light absorption layer composition (5) was obtained, wherein Table 2 shows component amount of the conductive light absorption layer composition (5). Next, the conductive light absorption layer composition (5) was coated on a glass substrate (connected to a circulating cooling water system) by blade coating to form a conductive light absorption layer (5) with a thickness of 1.03 μm (solid film), wherein the spacing between the blades was 20 μm.

Next, the sheet resistance of the conductive light absorption layer (5) was measured by an electrometer (Keithely 2000), and the result is shown in Table 3.

Next, a transparent substrate 12 (made of PET with a thickness of 125 μm), an electrode 14 (made of ITO with a thickness of 10-120 μm), a liquid crystal layer 16 (made of an encapsuled cholesteric liquid crystal by slot die coating with a thickness of 8-12 μm), the conductive light absorption layer (5), and an electrode 20 (made of silver with a thickness of 10-30 μm) were assembled to obtain the liquid crystal display according to FIG. 1. The driving voltage of the obtained display was measured and the result is shown in Table 3.

### EXAMPLE 2

2 g of an adhesion agent (QR-gel, Kodak QR gelatin) and 310 g of DI water were added into a reaction bottle. After stirring at 40° C. to completely dissolve the gelatin, 80 g of the magenta red pigment dispersion of Preparative Example 1, 40 g of the cyan pigment dispersion of Preparative Example 3, 10 g of the moidified ITO powder of Preparative Example 6, and 100 g of Baytron Pconductive polymer were added into the reaction bottle. After stirring for 30 min, the pH value of the mixture was adjusted to 5.2 by sulfuric acid and sodium hydroxide, and then 3.0 g of KCl aqueous solution (0.1N) serving as the interface modifying agent was added into the reaction bottle. After stirring for 1 hr, a conductive light absorption layer composition (6) was obtained, wherein Table 2 shows component amount of the conductive light absorption layer composition (6). Next, the conductive light absorption layer composition (6) was coated on a glass substrate (connected to a circulating cooling water system) by blade coating to form a conductive light absorption layer (6) with a thickness of 1.04 μm (solid film), wherein the spacing between the blades was 20 μm.

Next, the sheet resistance of the conductive light absorption layer (6) was measured by an electrometer (Keithely 2000), and the result is shown in Table 3.

Next, a transparent substrate 12 (made of PET with a thickness of 125 μm), an electrode 14 (made of ITO with a thickness of 10-120 μm), a liquid crystal layer 16 (made of an encapsuled cholesteric liquid crystal by slot die coating with a thickness of 8-12 μm), the conductive light absorption layer (6), and an electrode 20 (made of silver with a thickness of 10-30 μm) were assembled to obtain the liquid crystal display according to FIG. 1. The driving voltage of the obtained display was measured and the result is shown in Table 3.

### EXAMPLE 3

2 g of an adhesion agent (QR-gel, Kodak QR gelatin) and 310 g of DI water were added into a reaction bottle. After stirring at 40° C. to completely dissolve the gelatin, 60 g of the magenta red pigment dispersion of Preparative Example 1, 60 g of the yellow pigment dispersion of Preparative Example 2, 10 g of the moidified ITO powder of Preparative Example 6, and 100 g of Baytron Pconductive polymer were added into the reaction bottle. After stirring for 30 min, the pH value of the mixture was adjusted to 5.2 by sulfuric acid and sodium hydroxide, and then 3.0 g of KCl aqueous solution (0.1N) serving as the interface modifying agent was added into the reaction bottle. After stirring for 1 hr, a conductive light absorption layer composition (7) was obtained, wherein Table 2 shows component amount of the conductive light absorption layer composition (7). Next, the conductive light absorption layer composition (7) was coated on a glass substrate (connected to a circulating cooling water system) by blade coating to form a conductive light absorption layer (7) with a thickness of 1.06 μm (solid film), wherein the spacing between the blades was 20 μm.

Next, the sheet resistance of the conductive light absorption layer (7) was measured by an electrometer (Keithely 2000), and the result is shown in Table 3.

Next, a transparent substrate 12 (made of PET with a thickness of 125 μm), an electrode 14 (made of ITO with a thickness of 10-120 μm), a liquid crystal layer 16 (made of an encapsuled cholesteric liquid crystal by slot die coating with a thickness of 8-12 μm), the conductive light absorption layer (7), and an electrode 20 (made of silver with a thickness of 10-30 μm) were assembled to obtain the liquid crystal display according to FIG. 1. The driving voltage of the obtained display was measured and the result is shown in Table 3.

### EXAMPLE 4

2 g of an adhesion agent (QR-gel, Kodak QR gelatin) and 310 g of DI water were added into a reaction bottle. After stirring at 40° C. to completely dissolve the gelatin, 80 g of the magenta red pigment dispersion of Preparative Example 1, 40 g of the cyan pigment dispersion of Preparative Example 3, and 120 g of Baytron Pconductive polymer were added into the reaction bottle. After stirring for 30 min, the pH value of the mixture was adjusted to 5.2 by sulfuric acid and sodium hydroxide, and then 3.0 g of KCl aqueous solution (0.1N) serving as the interface modifying agent was added into the reaction bottle. After stirring for 1 hr, a conductive light absorption layer composition (8) was obtained, wherein Table 2 shows component amount of the conductive light absorption layer composition (8). Next, the conductive light absorption layer composition (8) was coated on a glass substrate (connected to a circulating cooling water system) by blade coating to form a conductive light absorption layer (8) with a thickness of 1.1 μm (solid film), wherein the spacing between the blades was 20 μm.

Next, the sheet resistance of the conductive light absorption layer (8) was measured by an electrometer (Keithely 2000), and the result is shown in Table 3.

Next, a transparent substrate 12 (made of PET with a thickness of 125 μm), an electrode 14 (made of ITO with a thickness of 10-120 μm), a liquid crystal layer 16 (made of an encapsuled cholesteric liquid crystal by slot die coating with a thickness of 8-12 μm), the conductive light absorption layer (8), and an electrode 20 (made of silver with a thickness of 10-30 μm) were assembled to obtain the liquid crystal display according to FIG. 1. The driving voltage of the obtained display was measured and the result is shown in Table 3.

TABLE 2

| | | | | interface |
|---|---|---|---|---|
| | adhesion | non-conductive | conductive | modifying |
| | agent | nano-pigment | material | agent |
| Comparative | gelatin | magenta red pigment | | |
| Example 1 | | dispersion (80 g) | | |
| | | cyan pigment | | |
| Comparative | gelatin | dispersion (40 g) | delami- | |
| Example 2 | | magenta red pigment | nated | |
| | | dispersion (80 g) | graphite | |
| | | cyan pigment | (10 g) | |
| | | dispersion (40 g) | | |
| Comparative | gelatin | magenta red pigment | Carbon | |
| Example 3 | | dispersion (80 g) | black | |
| | | cyan pigment | (100 g) | |
| | | dispersion (40 g) | | |
| Comparative | gelatin | magenta red pigment | ITO | |
| Example 4 | | dispersion (80 g) | powder | |
| | | cyan pigment | (10 g) | |
| | | dispersion (40 g) | | |
| Example 1 | gelatin | magenta red pigment | Carbon | NaOH, |
| | | dispersion (80 g) | black | KCl |
| | | cyan pigment | (100 g) | |
| | | dispersion (40 g) | Baytron P | |
| | | | (100 g) | |
| Example 2 | gelatin | magenta red pigment | ITO | NaOH, |
| | | dispersion (80 g) | powder | KCl |
| | | cyan pigment | (10 g) | |
| | | dispersion (40 g) | Baytron | |
| | | | (100 g) | |
| Example 3 | gelatin | magenta red pigment | ITO | NaOH, |
| | | dispersion (60 g) | powder | KCl |
| | | yellow pigment | (10 g) | |
| | | dispersion (60 g) | Baytron | |
| | | | (100 g) | |
| Example 4 | gelatin | magenta red pigment | Baytron | NaOH, |
| | | dispersion (80 g) | (120 g) | KCl |
| | | cyan pigment | | |
| | | dispersion (40 g) | | |

TABLE 3

| | thickness of solid | sheet resistance | display driving |
|---|---|---|---|
| | film (μm) | (Ω/□) | voltage (V) |
| Comparative | 1.06 | 3.2 × 10¹¹ | 160~180 |
| Example 1 | | | |
| Comparative | 0.98 | 9.2 × 10⁸ | 150 |
| Example 2 | | | |
| Comparative | 1.02 | 8.6 × 10⁶ | 120 |
| Example 3 | | | |
| Comparative | 1.05 | 2.26 × 10⁷ | 140 |
| Example 4 | | | |
| Example 1 | 1.03 | 2.9 × 10⁵ | 82 |
| Example 2 | 1.04 | 5.6 × 10⁵ | 85 |
| Example 3 | 1.06 | 6.9 × 10⁵ | 86 |
| Example 4 | 1.1 | 3.6 × 10⁶ | 75 |

Accordingly, since the interface modifying agent is added into the conductive light absorption layer composition of the disclosure, the conductive light absorption layer prepared from the conductive light absorption layer composition has lower sheet resistance (in comparison with Comparative Example 1-4) of between 1×10⁵-1×10⁸ Ω/□, thereby lowering the driving voltage (from 160-120V to about 80V) of the liquid crystal display employing the conductive light absorption layer.

While the disclosure has been described by way of example and in terms of the preferred embodiments, it is to be understood that the disclosure is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A conductive light absorption layer composition, comprising:
10-40 parts by weight of an adhesion agent;
40-50 parts by weight of a non-conductive nano-pigment;
10-25 parts by weight of a conductive material;
10-25 parts by weight of a surfactant; and
0.1-1.0 parts by weight of an interface modifying agent.

2. The conductive light absorption layer composition as claimed in claim 1, wherein the adhesion agent comprises cellulose esters, gelatins, gelatin derivatives, polysaccaharide, casein, poly(vinyl lactams), acrylamide polymers, poly(vinyl alcohol), hydrolyzed polyvinyl acetates, polymers of alkyl and sulfoalkyl acrylates and methacrylates, polyamides, polyvinyl pyridine, acrylic acid polymers, maleic anhydride copolymers, polyalkylene oxide, methacrylamide copolymers, polyvinyl oxazolidinones, maleic acid copolymers, vinyl amine copolymers, methacrylic acid copolymers, acryloyloxyalkyl acrylate and methacrylates, vinyl imidazole copolymers, vinyl sulfide copolymers, homopolymer or copolymers containing styrene sulfonic acid, or combinations thereof.

3. The conductive light absorption layer composition as claimed in claim 1, wherein the non-conductive nano-pigment comprises a single color non-conductive nano-pigment or a mixture of a non-conductive nano-pigments with various colors.

4. The conductive light absorption layer composition as claimed in claim 1, wherein the non-conductive nano-pigment has a grain size of less than 1 μm.

5. The conductive light absorption layer composition as claimed in claim 1, wherein the conductive material comprises conductive polymer, transparent conductive particle, metal particle, carbon particle, or combinations thereof.

6. The conductive light absorption layer composition as claimed in claim 1, wherein the interface modifying agent comprises ionic compound having a monovalent organic cation, bivalent organic cation, monovalent inorganic cation, or bivalent inorganic cation.

7. The conductive light absorption layer composition as claimed in claim 1, further comprising leveling agent, defoaming agent, adhesion assistant, or combinations thereof.

8. A conductive light absorption layer, made by coating the conductive light absorption layer composition as claimed in claim 1.

9. A liquid crystal display, comprising:
a transparent substrate;
a transparent electrode, disposed on the transparent substrate;
a liquid crystal layer, disposed on the transparent electrode;
a conductive light absorption layer, disposed on the liquid crystal layer, wherein the conductive light absorption layer is made by coating the conductive light absorption layer composition as claimed in claim 1; and
an electrode, disposed on the conductive light absorption layer.

10. The liquid crystal display as claimed in claim 9, wherein the conductive light absorption layer has a sheet resistance of between 1×10⁵-1×10⁸ Ω/□.

11. The liquid crystal display as claimed in claim 9, wherein the conductive light absorption layer has a thickness of between 0.1-1.2 μm.
